(19) United States
(12) Patent Application Publication
(10) Pub. No.: US 2026/0038316 A1
(43) Pub. Date: Feb. 5, 2026

(54) VEHICLE CONTROL UNIT AND VEHICLE CONTROL METHOD

(71) Applicant: ISUZU MOTORS LIMITED, Yokohama-shi (JP)

(72) Inventor: Naoya OSHIDA, Fujisawa-shi (JP)

(21) Appl. No.: 19/278,111

(22) Filed: Jul. 23, 2025

(30) Foreign Application Priority Data
Jul. 31, 2024 (JP) 2024-124445

(51) Int. Cl. G07C 5/08; B60R 16/03; H02P 1/02

(52) U.S. Cl. CPC G07C 5/0825; B60R 16/03; H02P 1/029

(57) ABSTRACT

A vehicle control unit includes a receiving part that receives an ON operation for causing an electronic device included in a vehicle to start up and an OFF operation for causing the activated electronic device to shut down, and a controller that controls startup of the electronic device or shutdown of the electronic device based on an operation received by the receiving part, wherein when the receiving part receives the ON operation before a predetermined time elapses after the receiving part receives the OFF operation, the controller causes the electronic device to initiate startup after the predetermined time has elapsed since the receiving part received the OFF operation.

### CROSS-REFERENCE TO RELATED APPLICATIONS

The present application claims priority to Japanese Patent Application number 2024-124445, filed on Jul. 31, 2024, contents of which are incorporated herein by reference in its entirety.

### BACKGROUND OF THE INVENTION

The present disclosure relates to a vehicle control unit and a vehicle control method.

When an ignition key is switched from an OFF state to an ON state, a conventional control device drives a motor that applies steering assist torque to a steering mechanism after a diagnostic process is performed by a control calculation unit that calculates a current for the motor (for example, Japanese Unexamined Patent Application Publication No. 2008-13146).

When a storage is configured to store diagnostic results of various devices provided in a vehicle after receiving an OFF operation from a driver to switch an ignition key to an OFF state, there is a possibility that the driver may perform an ON operation to switch the ignition key back to an ON state during the process of storing the diagnostic results. In such a case, the control device may restart the vehicle by interrupting the process due to the ON operation performed by the driver, which may result in a problem in which a device to be diagnosed is erroneously determined as being faulty, based on incorrect diagnostic results stored in the storage.

### BRIEF SUMMARY OF THE INVENTION

The present disclosure focuses on this point, and an object thereof is to restart a vehicle at an appropriate timing.

### Means for Solving the Problems

A vehicle control unit according to a first aspect of the present disclosure includes a receiving part that receives an ON operation for causing an electronic device included in a vehicle to start up and an OFF operation for causing the activated electronic device to shut down, and a controller that controls startup of the electronic device or shutdown of the electronic device based on an operation received by the receiving part, wherein when the receiving part receives the ON operation before a predetermined time elapses after the receiving part receives the OFF operation, the controller causes the electronic device to initiate startup after the predetermined time has elapsed since the receiving part received the OFF operation.

A vehicle control method according to a second aspect of the present disclosure is a vehicle control method, executed by a processor, includes the steps of receiving an ON operation for causing an electronic device included in a vehicle to start up and an OFF operation for causing the activated electronic device to shut down, and controlling startup of the electronic device or shutdown of the electronic device based on an operation received in the receiving, wherein when the ON operation is received before a predetermined time elapses after the OFF operation has been received in the receiving, startup of the electronic device is initiated after the predetermined time has elapsed after the OFF operation was received in the controlling.

### BRIEF DESCRIPTION OF THE DRAWINGS

FIG. 1 shows an overview of a vehicle control system S according to the present embodiment.

FIG. 2 shows an operation in which an MCU 4 initiates startup after a predetermined time has elapsed.

FIG. 3 shows an operation in which a controller 122 does not initiate startup of the MCU 4 due to a failure to satisfy a predetermined condition.

FIG. 4 shows an operation in which the MCU 4 initiates startup at a timing when an ON operation is received.

FIG. 5 is an example of a message indicating that a predetermined time P has not yet elapsed.

FIG. 6 is an example of a message indicating that the MCU 4 will not start up.

FIG. 7 shows an example of a processing sequence in a VCU 10.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Overview of Vehicle Control System S

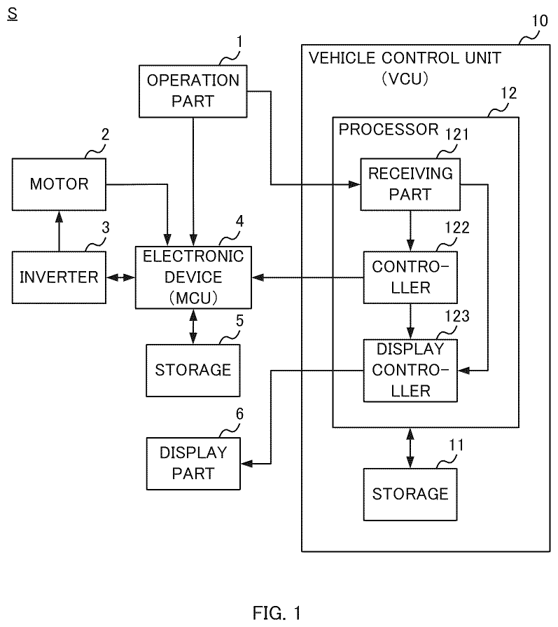

FIG. 1 shows an overview of a vehicle control system S according to the present embodiment. The vehicle control system S shown in FIG. 1 includes an operation part 1, a motor 2, an inverter 3, an electronic device 4, a storage 5, a display part 6, and a vehicle control unit 10. The vehicle control system S is mounted in a vehicle and has a function of controlling an operation of a drive source included in the vehicle. The drive source is the motor 2.

The operation part 1 includes an ignition key or a switch for starting or stopping the drive source of the vehicle equipped with the vehicle control system S, and an accelerator pedal of the vehicle. The motor 2 is an electric motor that converts electric energy into mechanical energy (kinetic energy), and is the drive source for driving the vehicle equipped with the vehicle control system S. The inverter 3 is a circuit for converting DC power output from a battery (not shown in figures) included in the vehicle into AC power and supplying the AC power to the motor 2.

The electronic device 4 is a control unit that controls the motor 2, and is a so-called Motor Control Unit (MCU). The electronic device 4 acquires i) an amount of depression of the accelerator pedal operated by a driver of the vehicle, ii) a current value of AC power supplied from the inverter 3 to the motor 2, and iii) an angle value detected by a resolver (angular displacement sensor) included in the motor 2, for example. Then, the electronic device 4 generates a Pulse Width Modulation (PWM) signal based on the acquired amount of depression, current value, and angle value, and outputs the generated PWM signal to the inverter 3, thereby controlling the output of the motor 2.

The electronic device 4 diagnoses at regular time intervals whether or not a failure has occurred in the inverter 3. For example, the electronic device 4 acquires a synthesized voltage obtained by combining output voltages of the respective phases of the inverter 3 as a voltage of a virtual neutral point corresponding to a neutral point of the motor 2, and diagnoses the inverter 3 based on the synthesized voltage. The electronic device 4 stores, in the storage 5, a diagnostic result obtained by diagnosing whether or not a failure has occurred in the inverter 3.

The storage 5 is a storage medium such as an Electrically Erasable and Programmable Read Only Memory (EEPROM). The storage 5 stores various types of information necessary for the electronic device 4 to control the motor 2 and the inverter 3. The storage 5 stores the diagnostic result obtained by the electronic device 4 diagnosing the inverter 3. The display part 6 is a display provided in an instrument panel of the vehicle, and is a multi-information display, for example.

The vehicle control unit 10 is a device that controls the vehicle provided with the drive source including the motor 2, and is a so-called Vehicle Control Unit (VCU). The vehicle control unit 10 has a function of causing the electronic device 4 to start up and shut down in response to the driver of the vehicle operating the ignition key or switch included in the operation part 1.

For example, the vehicle control unit 10 outputs, to the electronic device 4 via a Controller Area Network (CAN), a startup signal for causing the electronic device 4 to start up and a shutdown signal for causing the electronic device 4 to shut down. For example, upon receiving the ON operation performed by the driver to switch the ignition key or switch to the ON state from the operation part 1, the vehicle control unit 10 outputs the startup signal to the electronic device 4 to cause the electronic device 4 to start up. For example, upon receiving the OFF operation performed by the driver to switch the ignition key or switch to the OFF state from the operation part 1, the vehicle control unit 10 outputs the shutdown signal to the electronic device 4 to cause the electronic device 4 to shut down.

When the electronic device 4 receives the shutdown signal from the vehicle control unit 10, it performs a process related to shutdown (hereinafter referred to as the “shutdown process”) and then stops, and thus requires a predetermined amount of time (for example, 10 seconds) from receiving the shutdown signal to stopping. As one example, the shutdown process is a process of storing, in the storage 5, the diagnostic result obtained by diagnosing whether or not a failure has occurred in the inverter 3. Therefore, when the startup signal is received from the vehicle control unit 10 during execution of the shutdown process, the electronic device 4 interrupts the process for storing the diagnostic result in the storage 5 and initiates a restart. Thus, the electronic device 4 may erroneously determine that a failure has occurred in the inverter 3, using the diagnostic result that has been partially stored in the storage 5 (i.e., an incorrect diagnostic result).

Accordingly, when the ON operation is further received from the operation part 1 before a predetermined time elapses after the OFF operation is received from the operation part 1, the vehicle control unit 10 outputs the startup signal after the predetermined time has elapsed. The predetermined time is a time equal to or longer than a time required for the electronic device 4 to execute the shutdown process, for example. By controlling the timing at which the vehicle control unit 10 causes the electronic device 4 to restart in this manner, the vehicle control unit 10 can prevent the electronic device 4 from erroneously determining that the inverter 3 is faulty.

A configuration and operation of the vehicle control unit 10 will be described in detail below. In the following description, the electronic device 4 is referred to as an “MCU 4,” and the vehicle control unit 10 is referred to as a “VCU 10.”

### Configuration of VCU 10

As shown in FIG. 1, the VCU 10 includes a storage 11 and a processor 12. The processor 12 includes a receiving part 121, a controller 122, and a display controller 123.

The storage 11 includes a storage medium such as a Read Only Memory (ROM), a Random Access Memory (RAM), a Hard Disk Drive (HDD), or a Solid State Drive (SSD). The storage 11 stores a program executed by the processor 12 and various types of information for controlling the timing of initiating startup and shutdown of the MCU 4.

The processor 12 is a processor such as a Central Processing Unit (CPU) or an Electronic Control Unit (ECU). The processor 12 functions as the receiving part 121, the controller 122, and the display controller 123 by executing the program stored in the storage 11. The processor 12 may consist of one processor, or may consist of a plurality of processors or a combination of one or more processors and an electronic circuit.

The receiving part 121 receives the ON operation for causing the MCU 4 to start up and the OFF operation for causing the activated MCU 4 to shut down. For example, the receiving part 121 receives, from the operation part 1, the ON operation as an operation for causing the MCU 4 to start up, the ON operation is indicating that the driver has turned on the ignition key or switch of the operation part 1. For example, the receiving part 121 receives, from the operation part 1, the OFF operation as an operation for causing the MCU 4 to shut down, the OFF operation is indicating that the driver has turned off the ignition key or switch of the operation part 1.

The controller 122 controls startup of the MCU 4 or shutdown of the MCU 4 based on the operation received by the receiving part 121. For example, the controller 122 controls the timing of initiating shutdown of the MCU 4 in response to reception of the OFF operation by the receiving part 121. The controller 122 controls shutdown of the MCU 4, which is a control unit for controlling the motor 2, by outputting the shutdown signal to the MCU 4 at a time when the receiving part 121 receives the OFF operation or at a time subsequent thereto, for example.

For example, the controller 122 controls the timing of initiating startup of the MCU 4 in response to reception of the ON operation by the receiving part 121. The controller 122 controls startup of the MCU 4, which is a control unit for controlling the motor 2, by outputting the startup signal to the MCU 4 after the receiving part 121 receives the ON operation.

When the receiving part 121 receives the ON operation before the predetermined time elapses after receiving the OFF operation, the controller 122 causes the MCU 4 to initiate startup after the predetermined time has elapsed since the receiving part 121 received the OFF operation. The predetermined time is a time equal to or longer than a time required for the MCU 4, which controls the motor 2, to complete shutdown after the receiving part 121 has received the OFF operation, and is 10 seconds, for example. The predetermined time is stored in the storage 11.

For example, when the receiving part 121 receives the ON operation before the predetermined time elapses from a first timing at which the receiving part 121 received the OFF operation, the controller 122 causes the MCU 4 to initiate startup after the predetermined time has elapsed from the first timing. That is, when the receiving part 121 receives the ON operation before the predetermined time elapses from the first timing, the controller 122 outputs the startup signal after the predetermined time has elapsed from the first timing to cause the MCU 4 to initiate startup.

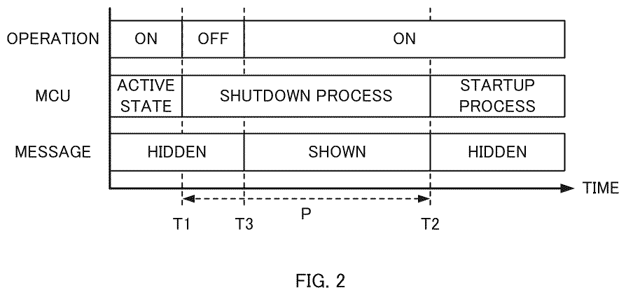

FIG. 2 shows an operation in which the MCU 4 initiates startup after the predetermined time has elapsed. The horizontal axis of FIG. 2 represents time, and the vertical axis of FIG. 2 represents “operation” which indicates the operation (ON operation or OFF operation) received from the operation part 1, “MCU” which indicates the process state of the MCU 4, and “message” which indicates whether or not the display controller 123 is causing the message to be displayed on the display part 6. Time T1 shown in FIG. 2 is the first timing, and time T2 is a second timing that is a time at which a predetermined time P has elapsed from time T1. A “shutdown process” shown in FIG. 2 includes a state in which the shutdown process is in progress and a state in which the MCU 4 is in a stopped state after the shutdown process has been completed. Details of the “message” caused to be displayed on the display part 6 by the display controller 123 will be described later.

As shown in FIG. 2, when the receiving part 121 receives the OFF operation at time T1, the controller 122 outputs the shutdown signal to the MCU 4 at time T1 or at a time subsequent to time T1 to cause the MCU 4 to initiate the shutdown process. Subsequently, at time T3, the receiving part 121 receives the ON operation before the predetermined time P elapses from time T1, and so the controller 122 outputs the startup signal at time T2 that is after the predetermined time P has elapsed from time T1. The MCU 4 then initiates the startup process by acquiring the startup signal at time T2.

When the controller 122 operates as described above, the MCU 4 can initiate the startup process after the shutdown process is completed even if the driver performs the ON operation before the shutdown process is completed. As a result, the controller 122 prevents the MCU 4 from initiating restart in a state where incorrect data is stored in the storage 5, for example. Further, the controller 122 is capable of causing the MCU 4 to start up after the MCU 4 has completed the shutdown process, even though the completion of the shutdown process cannot be notified to the VCU 10 after the MCU 4 has completed the shutdown process. As a result, the VCU 10 can restart the vehicle at an appropriate timing.

For example, if a predetermined condition is satisfied after the receiving part 121 receives the ON operation before the predetermined time P elapses after receiving the OFF operation, the controller 122 causes the MCU 4 to initiate startup after the predetermined time P has elapsed. The predetermined condition is that the receiving part 121 does not receive the OFF operation before the predetermined time P elapses. For example, as shown in FIG. 2, if the receiving part 121 does not receive the OFF operation during a time from time T3 at which the receiving part 121 receives the ON operation to time T2 at which the predetermined time P has elapsed, the controller 122 causes the MCU 4 to initiate startup at time T2.

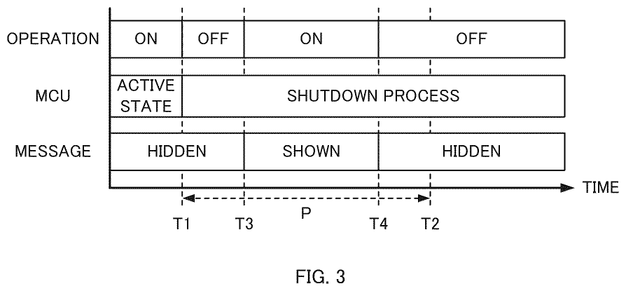

On the other hand, if the receiving part 121 receives the OFF operation during the time from time T3 to time T2 shown in FIG. 2, the controller 122 does not cause the MCU 4 to initiate startup at time T2 due to a failure to satisfy the predetermined condition. FIG. 3 shows an operation in which the controller 122 does not cause the MCU 4 to initiate startup due to a failure to satisfy the predetermined condition. The horizontal axis and the vertical axis in FIG. 3 are the same as the horizontal axis and the vertical axis in FIG. 2. Time T1, time T2, and time T3 shown in FIG. 3 are the same as time T1, time T2, and time T3 shown in FIG. 2. As shown in FIG. 3, when the receiving part 121 receives the OFF operation at time T4, which falls within a time period from time T3 to time T2, the controller 122 does not output the startup signal at time T2. As a result, the MCU 4 does not initiate startup after time T2.

By operating as described above, the controller 122 is capable of controlling whether to cause the MCU 4 to initiate startup after the predetermined time period P has elapsed, in accordance with the driver's operation, even during the predetermined time P in which the MCU 4 is executing the shutdown process. As a result, the controller 122 is capable of controlling the MCU 4 so as not to initiate startup according to the driver's operation, even in a case where the driver has erroneously performed the ON operation during the predetermined time P and subsequently performed the OFF operation, for example.

The controller 122 may control startup of the MCU 4 based on an operation that is closest in time to time T2, among a plurality of operations received by the receiving part 121 before time T2, which is a time point after the predetermined time P has elapsed from time T1. The controller 122, for example, causes the MCU 4 to initiate startup at time T2 when, among the plurality of operations received by the receiving part 121 during the predetermined time P, the operation received at the time closest to time T2 is the ON operation. On the other hand, the controller 122 does not cause the MCU 4 to initiate startup at time T2 when, among the plurality of operations received by the receiving part 121 during the predetermined time P, the operation received at the time closest to time T2 is the OFF operation.

By operating as described above, even if the driver erroneously performs the ON operation and the OFF operation a plurality of times during the predetermined time P, the controller 122 can control startup of the MCU 4 based on the operation last performed by the driver during the predetermined time P. As a result, the controller 122 is capable of matching the operational state of the operation part 1 performed by the driver with an active or stopped state of the MCU 4 at time T2.

When the receiving part 121 receives the ON operation after the predetermined time P has elapsed since receiving the OFF operation (i.e., after time T2 which is the second timing), the controller 122 causes the MCU 4 to initiate startup at the timing when the ON operation is received. That is, when the receiving part 121 receives the ON operation after time T2, the controller 122 outputs the startup signal at the timing when the ON operation is received to cause the MCU 4 to initiate startup.

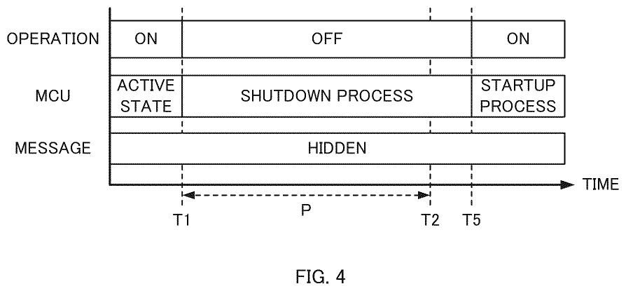

FIG. 4 shows an operation in which the MCU 4 initiates startup at the timing when the ON operation is received. The horizontal axis and the vertical axis in FIG. 4 are the same as the horizontal axis and the vertical axis shown in FIG. 2. Time T1 and time T2 shown in FIG. 4 are the same as time T1 and time T2 shown in FIG. 2. As shown in FIG. 4, when the receiving part 121 receives the ON operation at time T5 which is a time after time T2, the controller 122 outputs the startup signal at time T5 or at a time subsequent to time T5. Then, the MCU 4 initiates the startup process by acquiring the startup signal. The controller 122 operates as described above, and so the MCU 4 can start up without delay from the timing of the driver's ON operation after the completion of the shutdown process.

The display controller 123 controls whether or not to display a message on the display part 6. For example, the display controller 123 causes the display part 6 to display a message indicating that the predetermined time P has not yet elapsed, in response to the receiving part 121 receiving the ON operation before the predetermined time P elapses after receiving the OFF operation (i.e., from time T1 which is the first timing). The message is text data, for example, but may include an image or a moving image, or may be an image or a moving image corresponding to the text data.

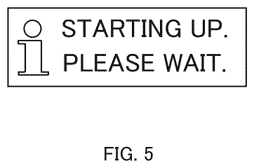

FIG. 5 is an example of the message indicating that the predetermined time P has not yet elapsed. As shown in FIG. 5, the display controller 123 causes the display part 6 to display a message indicating that the MCU 4 is in the startup process as a message indicating that the predetermined time P has not yet elapsed (i.e., the MCU 4 is in the shutdown process). Since the driver may assume that the shutdown process has been completed after performing the OFF operation, displaying a message related to the shutdown process by the display controller 123 when the ON operation is performed after the OFF operation may make it difficult for the driver to understand the state of the vehicle. Accordingly, the display controller 123 displays a message indicating that the startup process is in progress, instead of indicating that the predetermined time P has not yet elapsed, thereby making it easier for the driver to understand the state of the vehicle.

For example, as shown in FIG. 2, the display controller 123 causes the display part 6 to display the message shown in FIG. 5 in a time from time T3 when the receiving part 121 receives the ON operation to time T2 when the predetermined time P has elapsed. Then, the display controller 123 hides the message after the predetermined time P has elapsed since the receiving part 121 received the OFF operation. For example, the display controller 123 causes the message to be hidden after time T2 (i.e., after the second timing at which the predetermined time P has elapsed from the first timing). By operating in this manner, the display controller 123 is capable of notifying the driver of the state of the vehicle during a time when an operation of the vehicle differs from an operation of the vehicle corresponding to the driver's operation.

For example, after the receiving part 121 receives the ON operation before the predetermined time P elapses after receiving the OFF operation (i.e., from the time T1 which is the first timing), the display controller 123 hides the message when the receiving part 121 receives the OFF operation before the predetermined time P elapses. For example, when the receiving part 121 receives the OFF operation at time T4 shown in FIG. 3, the display controller 123 hides the message after time T4. By operating in this manner, the display controller 123 can hide the message according to the driver's operation, and thus the driver can easily grasp the state of the vehicle.

The display controller 123 may cause the display part 6 to display a message indicating that the MCU 4 will not start up, when the receiving part 121 receives the OFF operation before the predetermined time P elapses from time T1, after having received the ON operation within the predetermined time P. For example, the display controller 123 causes the message indicating that the MCU 4 will not start up to be displayed, when the receiving part 121 receives the OFF operation before the predetermined time P elapses, after having received the ON operation within the predetermined time P following reception of the OFF operation.

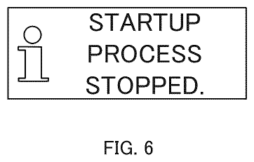

FIG. 6 is an example of the message indicating that the MCU 4 will not startup. As shown in FIG. 6, the display controller 123 causes the display part 6 to display a message indicating that the MCU 4 has stopped the startup process as a message indicating that the MCU 4 will not start up. For example, when the receiving part 121 receives the OFF operation at time T4 shown in FIG. 3, the display controller 123 causes the message shown in FIG. 6 to be displayed at time T4 or at a time subsequent to time T4.

By operating in this manner, the display controller 123 can notify the driver that the vehicle is operating according to the driver's operation. Furthermore, the display controller 123 displays that the MCU 4 has stopped the startup process, instead of displaying that the MCU 4 will not start up after time T2 (the second timing), thereby notifying the driver of the state of the vehicle using a message that is easier for the driver to understand

### Processing Sequence in VCU 10

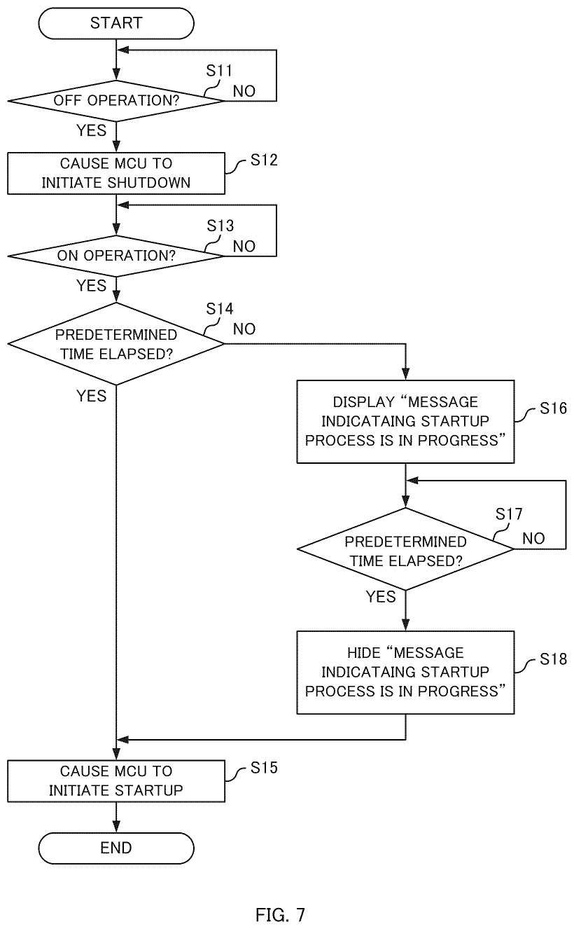

FIG. 7 shows an example of a processing sequence in the VCU 10. The processing sequence shown in FIG. 7 is a processing sequence showing an operation in which the VCU 10 causes the MCU 4 to initiate startup.

If the OFF operation is received from the operation part 1 (YES in step S11), the receiving part 121 outputs the shutdown signal to the MCU 4 to cause the MCU 4 to initiate shutdown (step S12). If the OFF operation is not received from the operation part 1 (NO in step S11), the receiving part 121 repeats the process of step S11.

If the receiving part 121 does not receive the ON operation (NO in step S13), the receiving part 121 repeats the process of step S13. If the receiving part 121 receives the ON operation (YES in step S13), the controller 122 determines whether or not the predetermined time has elapsed from the process of step S11 (step S14). If it is determined that the predetermined time has elapsed (YES in step S14), the controller 122 outputs the startup signal to the MCU 4 to cause the MCU 4 to initiate startup (step S15).

If it is determined that the predetermined time has not yet elapsed (NO in step S14), the display controller 123 causes the display part 6 to display a “message indicating that the startup process is in progress” shown in FIG. 5 (step S16). Then, if it is determined that the predetermined time has not yet elapsed from the process of step S11 (NO in step S17), the controller 122 repeats the process of step S17. If it is determined that the predetermined time has elapsed (YES in step S17), the display controller 123 hides the “message indicating that the startup process is in progress” shown in FIG. 5 (step S18), and the controller 122 causes the MCU 4 to initiate startup (step S15).

### Effect of VCU 10

As described above, the VCU 10 includes i) the receiving part 121 that receives the ON operation for causing the MCU 4 included in the vehicle to start up and the OFF operation for causing the activated MCU 4 to shut down, and ii) the controller 122 that controls startup of the MCU 4 or shutdown of the MCU 4 based on the operation to the receiving part 121. When the receiving part 121 receives the ON operation before the predetermined time elapses after receiving the OFF operation, the controller 122 causes the MCU 4 to initiate the startup process after the predetermined time has elapsed since the receiving part 121 received the OFF operation.

With the VCU 10 configured as described above, the MCU 4 can initiate the startup process after the shutdown process has been completed even if the driver performs the ON operation before the shutdown process has been completed. As a result, the VCU 10 can restart the MCU 4 after the MCU 4 has stored the correct data in the storage 5 in the shutdown process, thereby preventing the erroneous determination that the device (for example, the inverter 3) controlled by the MCU 4 is faulty. That is, the VCU 10 can restart the vehicle including the MCU 4 at an appropriate timing.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A vehicle control unit comprising:
a receiving part that receives an ON operation for causing an electronic device included in a vehicle to start up and an OFF operation for causing the activated electronic device to shut down; and
a controller that controls startup of the electronic device or shutdown of the electronic device based on an operation received by the receiving part, wherein
when the receiving part receives the ON operation before a predetermined time elapses after the receiving part receives the OFF operation, the controller causes the electronic device to initiate startup after the predetermined time has elapsed since the receiving part received the OFF operation.

2. The vehicle control unit according to claim 1, wherein
when the receiving part receives the ON operation after the predetermined time has elapsed since the receiving part received the OFF operation, the controller causes the electronic device to initiate startup at a timing when the ON operation is received.

3. The vehicle control unit according to claim 1, wherein
the vehicle control unit is a device that controls the vehicle including a drive source including a motor, and
the controller controls startup and shutdown of the electronic device, which is a control unit for controlling the motor.

4. The vehicle control unit according to claim 3, wherein
the predetermined time is a time equal to or longer than a time required for the electronic device, which controls the motor, to complete shutdown after the receiving part has received the OFF operation, and
the vehicle control unit further comprises:
a storage that stores the predetermined time.

5. The vehicle control unit according to claim 1, wherein
after the receiving part receives the ON operation before the predetermined time elapses after the receiving part receives the OFF operation, the controller causes the electronic device to initiate startup after the predetermined time has elapsed on condition that the receiving part does not receive the OFF operation before the predetermined time has elapsed.

6. The vehicle control unit according to claim 1, further comprising:
a display controller that causes a display part to display a message indicating that the predetermined time has not yet elapsed, based on the receiving part receiving the ON operation before the predetermined time elapses after the receiving part receives the OFF operation.

7. The vehicle control unit according to claim 6, wherein
the display controller hides the message after the predetermined time has elapsed since the receiving part received the OFF operation.

8. The vehicle control unit according to claim 6, wherein
the display controller hides the message, when the receiving part receives the OFF operation before the predetermined time elapses after the receiving part has received the ON operation within the predetermined time following reception of the OFF operation by the receiving part.

9. The vehicle control unit according to of claim 6, wherein
the display controller causes a message indicating that the electronic device will not start up to be displayed, when the receiving part receives the OFF operation before the predetermined time elapses after the receiving part has received the ON operation within the predetermined time following reception of the OFF operation by the receiving part.

10. A vehicle control method, executed by a processor, comprising the steps of:
receiving an ON operation for causing an electronic device included in a vehicle to start up and an OFF operation for causing the activated electronic device to shut down; and
controlling startup of the electronic device or shutdown of the electronic device based on an operation received in the receiving, wherein
when the ON operation is received before a predetermined time elapses after the OFF operation has been received in the receiving, startup of the electronic device is initiated after the predetermined time has elapsed after the OFF operation was received in the controlling.
